(19) United States
(12) Patent Application Publication
(10) Pub. No.: US 2017/0148260 A1
(43) Pub. Date: May 25, 2017

(54) Gaming Machine Location Optimization

(71) Applicant: William T. Dunn, Las Vegas, NV (US)

(72) Inventor: William T. Dunn, Las Vegas, NV (US)

(21) Appl. No.: 14/949,595

(22) Filed: Nov. 23, 2015

(51) Int. Cl. G07F 17/32

(52) U.S. Cl. CPC G07F 17/3234

(57) ABSTRACT

A position transmitter is associated with each gaming machine on a gaming establishment floor. The transmitter may be an RFID or GPS system. The location information and the performance data associated with each such gaming machine is compiled and an analysis of gaming machine data and performance may be used to enable efficient analysis of the floor layout. Machine usage and associated revenue may thus be optimized.

### TECHNICAL FIELD

The embodiments relate to gaming systems. More particularly, the embodiments relate to mapping systems to identify the location of various gaming machines in a casino gaming environment. By way of further characterization, but not by way of limitation thereto, the embodiments generate location and performance information for various gaming machines on a casino floor. In still greater particularity, the embodiments relate to a system which generates a visual representation correlating performance and location information for various gaming machines on a casino floor.

### BACKGROUND

Businesses can maximize profits and the value of the goods and services they provide to consumers by obtaining information on the location and identity of their inventory and other business assets. Bar code labels and readers have been used to provide this information in some applications. Because bar codes are optically read, a line of sight must be maintained between the reader and the label which limits the usefulness of bar codes. Alternative types of object location systems include Global Positioning Systems (GPS) and Radio Frequency Identification (RFID). GPS uses satellite transmission to provide precise location information and has global coverage but is generally limited to open area outdoor use due to line-of-sight issues caused by vegetation and buildings. That is, GPS requires an unobstructed line of sight view to multiple satellites to operate reliably.

RFID is the wireless use of electromagnetic fields to transfer data for the purposes of automatically identifying and tracking tags or labels attached to an object to be identified. The tags contain electronically stored information. Two-way radio transmitter-receivers sometimes called transceivers or readers send a signal to the tag and read its response. RFID technology uses electromagnetic signals from the targeted object containing information specific to that object. The electromagnetic waves do not require an unobstructed line of sight and are thus reliable indoors where another object may be present in the line of sight between the object and the transceiver.

RFID tags have been used in various applications and for various purposes. An RFID tag attached to an automobile during production can be used to track its progress through the assembly line. Pharmaceuticals can be tracked through warehouses. Livestock and pets may have tags injected, allowing positive identification of the animal. RFID applications are used in tracking of goods (inventory management) and in shipping and freight and distribution centers. RFID tags can be used with a database to identify the lading, origin, destination, etc. of targeted objects. The tag can be read inside a case, carton, box or other container. Another advantage in using RFID technology is that numerous RFID tags can be read simultaneously while bar codes can only be read one at a time using current devices.

### SUMMARY

In one embodiment, gaming machines in a casino are tagged with signal transmitting devices such as RFID tags. The tags are coded with each slot machine's manufacturer serial number as a unique identifier and they transmit casino floor location coordinates to a central receiving system that is automatically updated and saved on a regular basis. The floor coordinate information is stored and may render a visual overhead map representation of the arrangement of gaming machines in the casino at any given time. In some embodiments, other architectural features of the casino floor may be included to enhance the visual map representation.

In other embodiments, the map representation may be connected with the gaming machine performance data stored in the casino's accounting database correlated with the machine serial number, thus creating the ability to join the visual map representation to information about the actual machines (such as manufacturer, game name, bank identification, etc.). This enables machine performance accounting data to be included in the visual map summary. In some embodiments, the physical groupings of banks of machines derived from the location coordinate and machine configuration data may automatically identify existing and any proposed bank shapes and machine seat positions on any particular bank of machines. Gaming establishment personnel may manually edit the automatic identifications to include proposed bank grouping or gaming machine locations. The system regularly updates information and thus eliminates outdated casino floor maps and enables efficient analysis of gaming machine performance data in conjunction with the floor location variables. The combined map representation and performance data allows a casino operator to locate machines to improve performance and optimize revenue.

### BRIEF DESCRIPTION OF THE DRAWINGS

FIG. 1 shows a gaming machine including a position transmitter;

FIG. 2 is a rear view of a gaming machine with attached position transmitter;

FIG. 3 is a schematic diagram illustrating the operation of a transponder and transceiver in an RFID system;

FIG. 4 is a schematic illustrating the operation of a transponder;

FIG. 5 is a schematic illustrating the operation of a transceiver;

FIG. 6 is an overhead map of a casino floor including gaming machines;

FIG. 7 is a map of the casino floor generated using information received from RFID technology; and

FIG. 8 is a flow chart illustrating a method for generating a location and performance based map of gaming machines on a casino floor.

### DETAILED DESCRIPTION

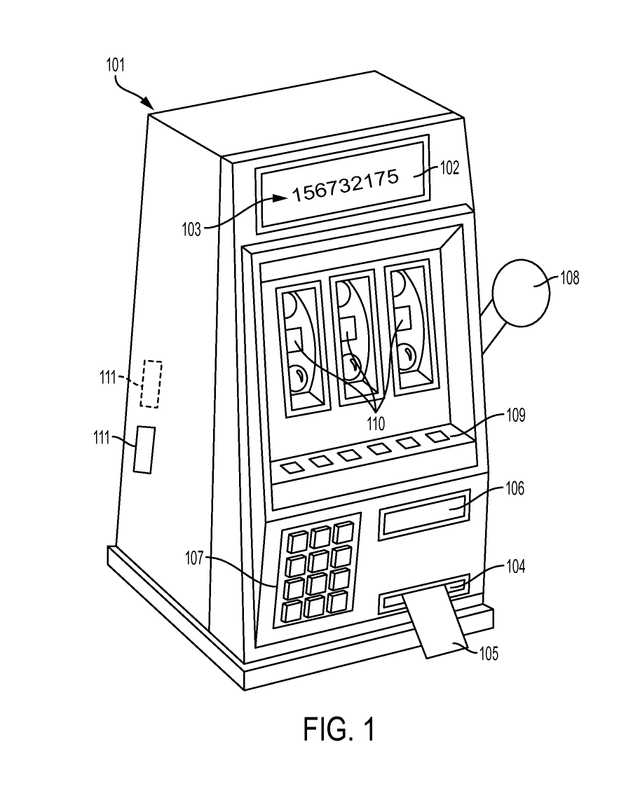

Reference will now be made in detail to representative embodiments illustrated in the accompanying drawings and in particular with reference to FIGS. 1-8. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims. Those skilled in the art will readily appreciate that the detailed description given herein with respect to these Figures is for explanatory purposes only and should not be construed as limiting.

Casino floor maps assist gaming establishment managers in efficiently deploying gaming machines on a casino floor. These maps join machine performance and player data to create a visual overhead map. Machine locations may be manually derived from the Cartesian (X,Y) or other coordinates of the casino floor. For example, some systems use reader software such as AutoCad or other commercially available software and a user may position the curser over each machine on the map, write down the coordinates, and append performance data with the machine location information. This is very tedious and time consuming process.

The above manual method for generating performance maps can be a complicated and involved process. Machine position coordinates must be gathered and matched with a machine serial number to join to machine configuration data, such as machine location (typically area, bank, and position number) and machine accounting data. Sample machine configuration data could include machine serial number, manufacturer name, game type, wagering amount, andgame location (area A, bank 01, position 06) on the casino floor. The machine accounting data, obtained from the casino database, includes performance data that the machine had 5,000 wagers and generated $100 in revenues during a certain time period.

As the above-described process is done for each machine a table may be constructed as shown below (Table 1) for all the machines on the casino floor. For example, from Table 1, it may be discerned that Bank A-01 has six machines (Serial #'s 12340-12345). The X,Y coordinates can be determined in various ways. A reference point (0,0) may be established somewhere on the casino floor and each machine location may be determined relative to that reference point (in feet, inches or some other distance measurement). By knowing the location of various machines and correlating that location information with individual machine performance information, a visual representation may be generated which allows a casino operator to determine optimum bank shapes and end or inner seat positions of the machines within the bank. Optimizing placement of each machine results in optimizing performance of the entire casino floor to improve the player experience and maximize revenue to the gaming establishment

TABLE 1

| Serial | Location | X | Y | REVENUE | WAGERS |
|---|---|---|---|---|---|
| 12340 | A-01-01 | 442 | 976 | $100 | 5000 |
| 12341 | A-01-02 | 442 | 1004 | $80 | 4000 |
| 12342 | A-01-03 | 442 | 1032 | $120 | 6000 |
| 12343 | A-01-04 | 479 | 1032 | $$$ | ### |
| 12344 | A-01-05 | 479 | 1004 | $$$ | ### |
| 12345 | A-01-06 | 479 | 976 | $$$ | ### |

From Table 1 above, it can be determined that bank A-01 includes six machines in a rectangular configuration with a vertical orientation (because the Y coordinate changes for each X coordinate) and that there are three machines on each side because the X coordinates are identical on each side (442, 479). It can also be determined from Table 1 that position 1 (A-01-01) is an end seat, A-01-02 is a middle seat and A-01-03 is an end seat. The Y-coordinate information shows that the distance between machines is about 28 inches (1004-976; 1032-1004; and so on) if inches are used as the measuring unit. Similarly, the other side of the bank (machines 4, 5, 6) provides similar position information.

As stated above, the position information may be correlated with performance information of each machine based upon the machine serial number. For example, again referring to Table 1, machine serial number 12340 in position 1 on Bank A-01 may, for example, have had 5000 wagers and have generated $100 in revenues on the previous day. Machine serial number 12341 in position 2 may have only had 4000 wagers and generated $80 in revenues on the previous day. Machine serial number 12342 in position 3 may have had 6000 wagers and generated $120 in revenues on the previous day. Thus, the performance of the gaming machines may be compared based upon machine location both on the floor and within the bank, and also compared with the same type of machine in other locations on the casino floor.

While the information such as in Table 1 can be useful, it can be difficult, tedious and time consuming to compile. Machine locations may be changed as casino floor managers relocate certain machines (possibly based upon information received from Table 1) or if new machines are added. Thus, a determination of machine location is important to generating useful performance data for floor managers in a gaming establishment. By correlating the performance data with machine location a useful visual representation may be generated to allow gaming establishment management to maximize user satisfaction and, ultimately, to maximize gaming revenue from the machines.

In order to generate the position information of various gaming machines on a casino floor, an electronic transmitter such as a Global Positioning System (GPS) Device or an Radio Frequency Identification (RFID) device or other position fixing devices may be employed. An antenna may be deployed at a known location within the casino and used to provide a reference point or a Wi-Fi network employed by the casino may be used to receive position information from the location devices. Currently, RFID tags are relatively cost effective but any position location technology may be utilized to generate machine position information in the gaming establishment.

RFID tags can be passive, active or battery-assisted passive. An active tag has an on-board battery and periodically transmits its identification signal and may operate many meters from the reader. A battery-assisted passive (BAP) has a small battery connected to the tag and is activated when in the presence of an RFID reader. A passive tag is cheaper and smaller because it has no battery. Instead, the tag uses the radio energy transmitted by the reader to power the tag. However, to operate a passive tag, it is typically illuminated with a power level roughly a thousand times stronger than is used for signal transmission, which may cause electromagnetic interference. All three of these types of RFID tags, passive, active and battery-assisted passive, may be used with the embodiments described herein.

RFID tags may either be read-only, having a factory-assigned serial number that is used as a key into a database, or may be read/write, where object-specific data can be written into the tag by the system user. Field programmable tags may be write-once, read-multiple and “blank” tags may be written with an electronic product or identification code by the user. All three of these types of RFID tags, read-only, read/write, or write-once read multiple, may be used with the embodiments described herein.

RFID tags contain at least two parts: an integrated circuit for storing and processing information, modulating and demodulating a radio-frequency (RF) signal, collecting DC power from the incident reader signal, and other specialized functions; and an antenna for receiving and transmitting the electromagnetic signal. The tag information may be stored in a non-volatile memory for example. The RFID tag includes either fixed or programmable logic for processing the transmission and sensor data, respectively.

In operation, an RFID reader transmits an encoded radio signal to interrogate the tag. The RFID tag receives the message and then responds with its identification and other information. This may be only a unique tag serial number, or may be product-related information such as a gaming machine serial number, lot or batch number, production date, location, or other specific information. Since tags have individual serial numbers, the RFID system design can discriminate among several tags that might be within the range of the RFID reader and read them simultaneously.

Fixed RFID readers are set up to create a specific interrogation zone which can be tightly controlled. This allows a highly defined reading area permitting tags to go in and out of the interrogation zone. Mobile readers may be hand-held or mounted on carts or vehicles or placed in a central location adjacent to the gaming establishment floor and hidden from view. RFID offers advantages over manual systems or use of bar codes. The tag can be read as long as it is within range of a reader, even if it is covered by an object or otherwise not visible.

Referring to FIG. 1, a gaming machine which may include a slot machine 101 is illustrated in perspective view. While a slot machine is shown, gaming machine 101 could include other types of machines such as video poker or skill based games or the RFID tags could be attached to table games such as roulette or blackjack tables. Gaming machine 101 includes a display screen 102 which may display various types of information 103 associated with a player or with the machine itself. In one embodiment, slot machine 101 may include a magnetic card reader 104 into which a player loyalty card 105 may be inserted. Information from card 105 read by card reader 104 may provide the player loyalty account information 103 displayed on display screen 102. If a player wishes to wager using a credit card this may also be inserted in card reader 104. A player may choose to input cash into bill validator 106 or he or she may choose to wager from a credit voucher obtained from a wagering event at another machine which may also be placed into validator 106.

In some embodiments, a player may be asked to input additional player data such as wagering account information through the use of a keypad 107. As with the machine performance data, this information may be stored in the casino database and used in conjunction with the position and identification information to generate a performance map. The player may initiate play on slot machine 101 by pulling handle 108 or pressing betting keys 109 depending upon the type of slot machine or the player's preference. Upon playing slot machine 101, the matching icons visible in windows 110 indicate whether a player has won or lost the wager. When a player has determined to end the gaming session, he or she may depress one of buttons 109 designated for that purpose or input an instruction through keypad 107 or touchscreen 102 in order to end that gaming session. An electronic position transmitter 111 which may include an RFID (Radio Frequency Identification) chip or a GPS system may be placed in or on machine 101.

The electronic position transmitter 111 may, in some embodiments, be coded with each slot machine's manufacturer serial number as a unique identifier. The tags will transmit location coordinates (X-Y or other types of coordinates to identify its location on a gaming floor) to a central computer system that is automatically updated and saved on at least a daily basis. Using the X-Y coordinate information, data is stored to render overview map type representation of the arrangement of slot machines in the casino at any given time.

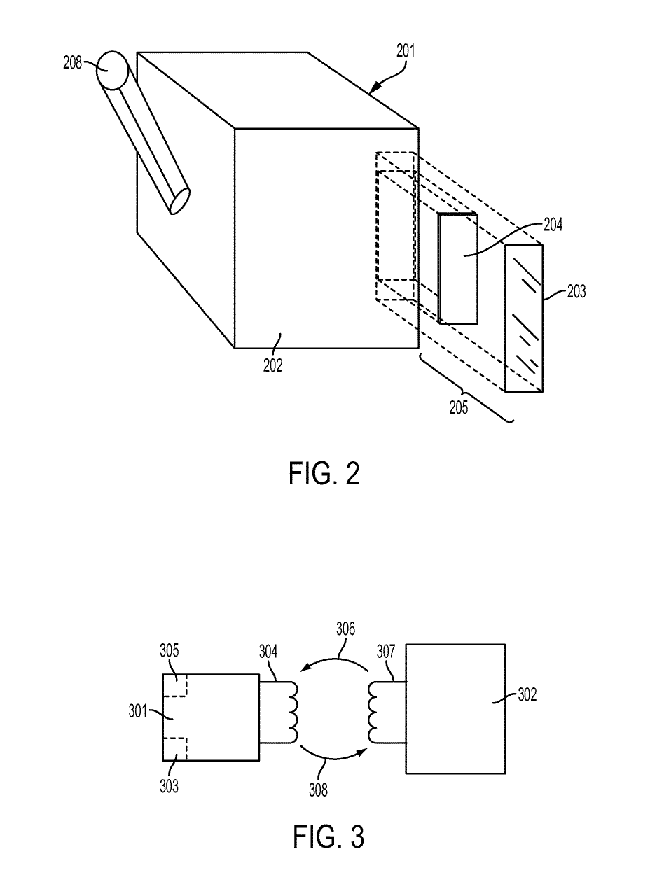

Referring to FIG. 2 the rear face portion 202 of gaming machine 201 may include a standard adhesive-type label portion 203 which is configured for attachment to the rear portion 202 of gaming machine 201. Label portion 203 may have human-readable and/or machine-readable information imprinted on its outer surface. For example, label portion 203 may be a conventional label including an alphanumeric code and a bar code. This human-readable and/or machine-readable information may include information identifying the machine which may include its serial number, manufacturer, date placed into service, etc. An electromagnetic transponder which may be an RFID transponder 204 may be disposed between label portion 203 and gaming machine rear surface 202. RFID transponder 204 and label portion 203 may comprise an RFID tag 205. In this embodiment, RFID transponder is placed on the rear face 202 of machine 201 but it should be expressly understood that in other embodiments, RFID transponder 204 may be placed on the front, side, top or other exterior or interior surfaces of machine 201.

In another embodiment, the RFID tag 205 shown in FIG. 2, may include label portion 203 and RFID transponder 204 in a single integral label. For example, label portion 203 may be printed directly on RFID transponder 204. Moreover, transponder 204 need not be directly coupled to label portion 203. For example, in other embodiments, transponder 204 may be integrated into or positioned on the interior of gaming machine 201 while label portion 203 is attached to the outer rear surface 202 of the gaming machine 201 as shown in FIG. 2. For example, referring to FIG. 1, transponder 111 is shown in phantom positioned within gaming machine 101 and in solid line positioned on the exterior of gaming machine 101.

Referring again to FIG. 2, label portion 203 may be similar to a conventional label and include bar-coded and/or human readable information. This may facilitate backward compatibility of the label 205 with existing systems and enable gaming establishment employees to visually verify certain information. In an alternate embodiment, however, label portion 203 may be omitted altogether such that RFID tag 205 comprises only transponder 204. The term “label” as used hereinafter shall refer to tag 205 which includes transponder 204 but may or may not include label portion 203.

Referring to FIG. 3, a schematic diagram illustrates the operation of transponder 301 and transceiver 302. An RFID transceiver 302 is used to read data from transponder 301. RFID technology uses an incident electromagnetic field from a transceiver 302 to induce power generation in an antenna 304 of a (normally passive) transponder 301. This power supply enables an active semiconductor device 303 within the transponder 301 to transmit a signal containing the information (metadata including machine identification and location) stored in a memory 305 of the transponder 301 back to the transceiver 302. An electromagnetic signal 306 is transmitted from an antenna 307 of transceiver 302 and is received by an antenna 304 of RFID transponder 301. Transponder 301 then modulates signal 306 with data stored in a memory 305 which in some embodiments may be an electrically erasable, programmable, read-only memory, or EEPROM 303. The modulated signal, including the data from transponder 301, is then broadcast from antenna 304 as a data signal 308. Data signal 308 is received by antenna 307 of read transceiver 302. In one embodiment, this data signal 308 may include location information of a gaming machine associated with the transponder 301. That is, the RFID tag 205 on the gaming machine may include transponder 301.

Referring again to FIG. 3, data signal 308 may also include gaming machine identification and associated gaming machine performance information in some embodiments. In this manner, data stored within transponder 301 is “read” by RFID read transceiver 302. The reading is done without requiring physical contact between transceiver 302 and transponder 301. This permits a gaming machine associated with transponder 301 to be located at any point on a casino floor and that location may be read by transceiver 302 located in a central location in the casino. All gaming machines so equipped with a transponder 301 will have their locations read by transceiver 302 and a map of those locations may be generated as will be discussed below.

As used herein, the terms “electromagnetic transponder” or “transponder” includes both electromagnetic and electrostatic transponder technologies. Moreover, RFID devices may be implemented in any frequency range using free space optical frequencies. In some embodiments, it is also possible to implement the transponder devices using sonic (ultrasound) signal transmission rather than electromagnetic signal transmission. Furthermore, a variety of ways for implementing transponder 301 and read transceiver 302 may be used in various embodiments.

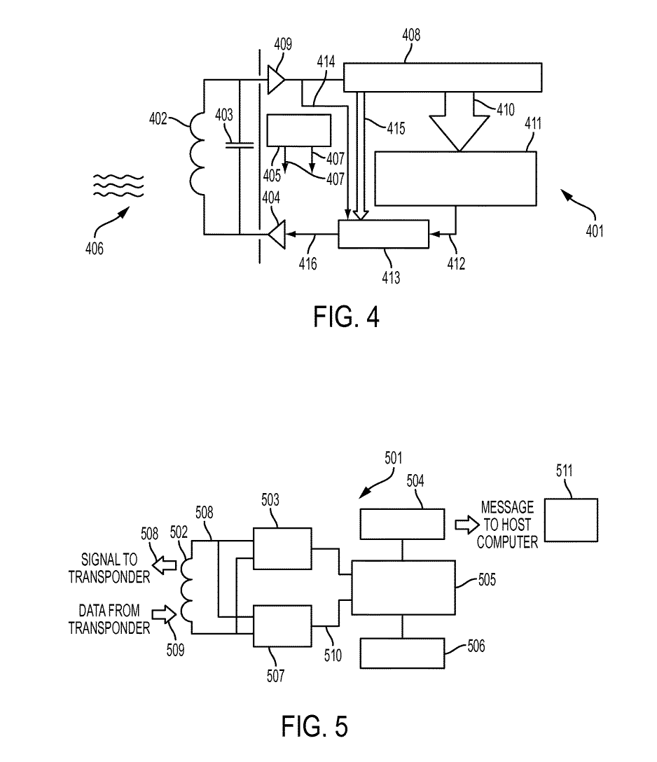

Referring to FIG. 4, an example implementation of transponder 401 is illustrated. In this example, transponder 401 is a passive transponder (i.e., transponder 401 has no power source of its own). Note, however, that transponder 401 may include a power source and be an active transponder in some embodiments. Transponder 401 includes antenna 402, a filter capacitor 403, an input buffer 404, and a power circuit 405 which may include a rectifier/regulator (not shown). Antenna 402 receives an excitation signal 406 from a transceiver (not shown). A portion of the energy from signal 406 is used by power circuit 405 to generate power 407 for the active components of transponder 401.

Referring again to FIG. 4, counter 408 receives signal 406 via input buffer 409 and produces a memory address signal 410 to scan memory 411. In response to the memory address signal 410, memory 411 outputs a data signal (metadata) 412 which may contain gaming machine identification and performance information to encoding integrated circuit 413. Encoding circuit 413 also receives a clock signal 414 and an encoding timing signal 415 and outputs an encoded data signal 416 to antenna 402 through output buffer 404. The encoded data signal 416 is then transmitted by antenna 402 for receipt by an antenna on a transceiver (not shown). This is an example of full duplex mode of operation in that excitation signal 406 and encoded data signal 416 may be simultaneously present on antenna 402.

FIG. 5 illustrates an example implementation of transceiver 501. Transceiver 501 includes antenna 502, an exciter circuit 503, an output interface circuit 504, a microprocessor circuit 505, a memory 506 which in some embodiments may be an electrically erasable, programmable, read-only memory, or EEPROM. Transceiver 501 also includes a receiver 507. In operation, exciter 503 produces excitation signal 508 for transmission by antenna 502 to transponder (not shown) such as that described in FIG. 4. Receiver 507 receives signal 509 which includes data from the transponder. Because signals 508 and 509 are simultaneously present on antenna 502, receiver 507 also receives excitation signal 508 directly from exciter circuit 503 and subtracts excitation signal 508 from the combined signal on antenna 502 to produce the data signal 510. It should be noted that, in some embodiments, more than one antenna 502 may be used to enhance signal reception as suggested by engineering design considerations. Microprocessor circuit 505 controls operation of exciter circuit 503 and receives data signal 510 from receiver 507. Data signal 510 may then be stored in memory circuit 506. Output interface 504 allows data signal 510 to be output to a host computer or network system 511 which may be a computer located on or remote from the premises of the gaming establishment.

Microprocessor circuit 505 may execute instructions and carry out operations associated with electronic devices as are described herein. Using instructions from memory 506, microprocessor 505 may regulate the reception and manipulation of input and output data between components of transceiver 501. Microprocessor 505 may be implemented in a computer chip or chips. Various other architectures can be used for microprocessor 505 such as application specific integrated circuits (ASIC's) and so forth. Microprocessor 505 together with an operating system may execute computer code and manipulate data. The operating system may be a well-known system such as iOS, Windows, Unix or a special purpose operating system or other systems as are known in the art. Microprocessor 505 may include memory capability to store the operating system and data. Microprocessor 505 may also include application software to implement various functions associated with the RFID tag.

The embodiments described above for transponder 401 and transceiver 501 are read-only devices. The devices were selected for illustration of the principles of the RFID technology and for ease of discussion. In some embodiments, however, the devices will be implemented using read/write technology. For writing data, transceiver 501 and transponder 401 operate in a manner substantially similar to the embodiment used herein when data is being read. For writing data to transponder 401, signal 508 may be modulated with a data signal. The data will then be extracted from the underlying carrier signal using a receiver circuit and will be stored in memory 411 of transponder 401. Configuration and operation of a writable transponder and a read/write transceiver will be apparent to a person skilled in RFID technology. For example, the read and write function could be accomplished using separate communication channels.

Casinos or other gaming entities utilize various types of gaming machines such as slot machines, video poker machines and the like. Knowing the location and presentation of those machines is important in enhancing the experience of gaming customers and maximizing the play of those customers and thus the revenue to the gaming establishment. Thus, these gaming entities seek to track information on the type and location of these gaming machines. Previously, the information has been tracked and recorded on hard copy maps or logs.

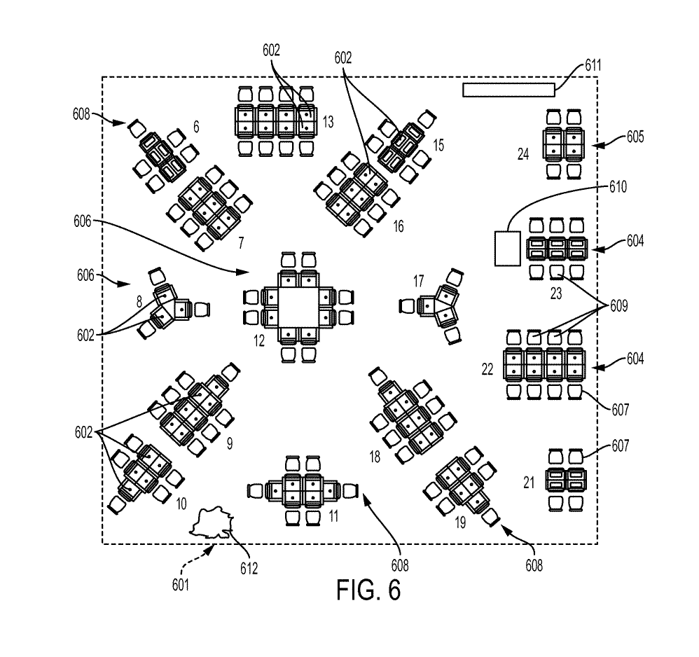

FIG. 6 illustrates a mapped representation of a casino floor 601 shown with various types of gaming machines 602 arranged in various banks 603 (numbered 6-13, 15-19; 21-24) shown at various locations on the casino floor 601. Machines 602 are typically grouped into banks 603 of games in various shapes and sizes such as rectangles 604 (bank numbers 6-11, 13, 15, 16, 18, 19, 22, 23), linear 605 (banks 21, 24), rounds 606 (banks 8, 12, 17), etc. and seat position on a bank (end seat 607, end cap 608, middle/inner seat 609) are known to affect customer game performance and usage. Mapped representations such as that shown in FIG. 6 may be generated by computer aided (CAD) software and may be used by gaming establishments to design and manage casino floor 601 to optimize revenue and player usage. Casino electronic apparatus 610 which may be a router or other casino apparatus may be depicted on the visual representation. Apparatus 610 may, for example, be connected to, and provide performance or other data related to gaming machines 602, to the casino database. Architectural features such as pony wall 611 and plant 612 may also be shown on the floor map to enhance the visual representation of floor 601.

The geography of a gaming establishment and, in particular, of gaming machine locations on the floor of the gaming establishment, is not static. Mangers at casinos often move machines around the casino floor and reconfigure areas for a variety of reasons, such as looking to improve game performance, lines of sight for customers, or to accommodate the addition or removal of machines as part of architectural redesigns in the casino. Because slot machines may move around, the hard copy floor map such as that described in FIG. 6 may often not stay updated with those moves. Moreover, even when the hard copy location maps are kept up-to-date, the floor map micro-location of machines may not be integrated with machine performance data.

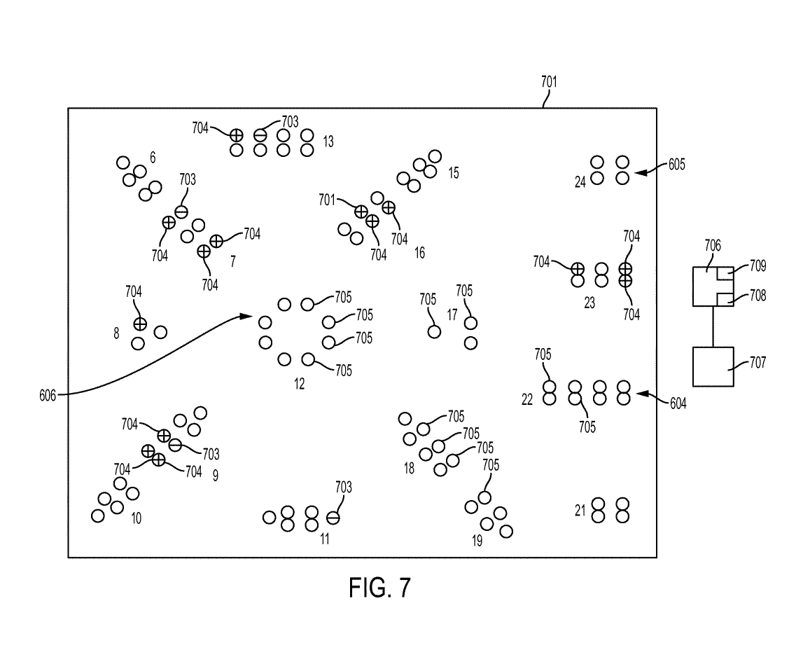

Referring to FIG. 7, a map of casino floor 701 is shown which coincides with the layout of machine banks 603 in FIG. 6. The map of FIG. 7 is generated by using RFID tags associated with each of gaming machines with each circle representing a gaming machine location and associated performance (for example the total amount of money wagered and or the total amount of money won by players at that machine) as recorded from data received from RFID tags on machines. In FIG. 7, the circles 703 (minus “−” sign in the circle) represent low performing machines while circles 704 (plus “+”sign in the circle) represent high performing machines and circles 705 (blank circle) represent average performing machines. In some embodiments, the circles may be color coded to represent the higher and lower performing gaming machines. The color coding may provide a variety of ratings other than high, low, and average as “in between” ratings may also be used. In other embodiments, geometric shapes other than circles may be used to represent the gaming machines.

In some embodiments, the map representation of the slot machine configuration data may be stored in the casino's slot accounting database 708 in computer 706 which is electromagnetically connected to the RFID transceiver 707. The RFID tags on each gaming machine wirelessly transmit location and performance data to transceiver 707 which may be located on the casino floor or in a location remote and hidden from the casino floor so as not to be visible by players. In some embodiments, transceiver 707 may be mounted or supported on a mobile machine or cart which may be moved throughout the gaming establishment by an employee to read the signals from the transponders. In this embodiment the power and signal requirements may be lower. Computer 706 may also be mobile, mounted on the same machine or cart, or it may be at a fixed location and wirelessly connected to transceiver 707.

The RFID transceiver 707 may electromagnetically receive the gaming machine serial number information from the transponder, thus creating the ability to join the visual representation to information about the actual machines (such as Manufacturer, game name, bank identification, etc.). This also enables the correlation of machine performance accounting data with location information (high, average, and low). The physical groupings of machines derived from the X-Y coordinate and machine configuration data may be used to automatically identify bank shapes and machine seat positions (as described above with respect to Table 1) on any particular bank of machines correlated with their performance. The casino management may manually edit the automatic identifications to customize the location map in an effort to visualize proposed new gaming machine placement. The information generated may be displayed on a map such as in the embodiment of FIG. 7 or it may be displayed visually such as on a screen 709 associated with computer 706 or on a mobile phone or laptop computer or other electronic device.

The gaming establishment management may then use this data to correlate the type of machine and the location of machines to optimize machine usage and maximize revenue. For example, a low revenue generating machine may be in one location in a bank while the same type of machine positioned in a more accessible bank, may generate significantly more revenue. Even within banks, management may identify higher performing locations or types of machines. Similarly, casino management may determine that a circular bank of machines may generate more revenue per machine than a linear bank of the same type of machines. The type of machines may vary from slot machines to video poker to various other type of gaming machines utilized by gaming establishments.

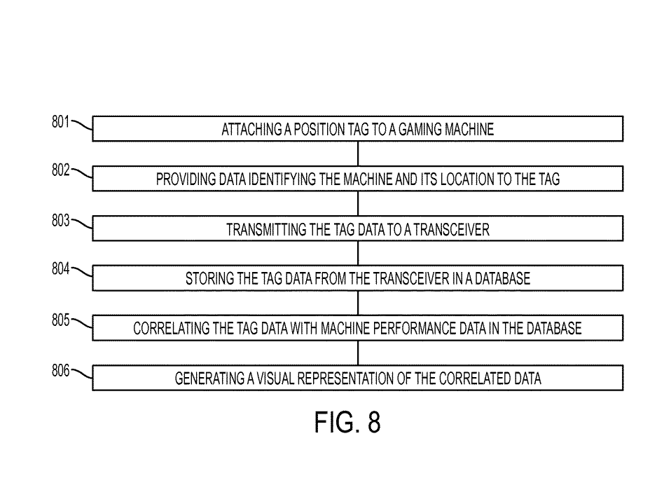

Referring to FIG. 8 a flowchart of a method for generating a visual representation of gaming machine location and performance data is shown. In operation 801, a position transponder which may be an RFID tag is attached to a gaming machine on a casino floor. In operation 802, data identifying the machine and its location is provided to the transponder. In operation 803, the data from the transponder is transmitted to the transceiver which is then transmitted to the gaming establishment database. The data is stored in a database in operation 804. Operation 805 correlates the identification and position data from the position tag with machine performance data in the casino database. Operation 805 may also include the optional operation of providing player data from the player identification card such as a loyalty card used in the machine. Particular player usage of a particular machine may thus be tracked. In operation 806, a visual representation is generated which in one embodiment may be a map of the casino floor with each gaming machine identified by location and performance.

By tracking the location and performance of individual gaming machines as well as the performance of various configurations, gaming establishment management may be better able to understand and maximize the revenue potential of every gaming machine and every gaming machine location on the gaming floor. Similarly, gaming establishment management may better identify games that are underperforming and determine whether the cause of the underperforming machines is due to the type of gaming machine or the location of the gaming machine. Gaming machines may be moved to different locations on the gaming floor to maximize performance.

By determining the usage of various machines at various locations, the gaming establishment management can also better manage the type and location of various gaming machines to correlate the supply of gaming machines with the user demand for them. The gaming establishment management may use the information generated by the RFID tags to negotiate with gaming machine suppliers for different types of gaming machines by obtaining price reductions in underperforming machines. The location data from the RFID tags may be immediately available and permits management to quickly see the results of moving gaming machines and the addition of new types of gaming machines including some types of machines which may be trial machines intended for specific player data, including demographics such as age, accessibility and the like. For example, a younger demographic may prefer one type of game while an older demographic may prefer a different type of game. By recording player data such as loyalty information and correlating that information with the type and location of the gaming machine, the gaming establishment management may be better able to maximize the revenue associated with various gaming machines. The location of the gaming machines, whether in a corner of the casino floor, for example, may affect usage by older players who are less likely to venture away from the center of a casino floor. The use of player demographics, location and performance data may thus be used to maximize revenue. The disclosed embodiments also solve the problem of the casino floor maps being outdated and enable the generation of up to date maps in a short timeframe.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings. For example, while certain gaming machines have been disclosed in certain embodiments as slot machines, it should be expressly understood that any type of gaming machine such as video poker machines or other machines employing games of chance may utilize the embodiments disclosed herein. While the visual representation has been disclosed with respect to a map and display on a computer screen, it should be understood that the visual representation may also be displayed on another device including a portable electronic device such as a laptop computer, tablet or mobile telephone in some embodiments.

1. A system for managing a plurality of gaming machines located in a gaming establishment comprising:
a location transmitter associated with each of the plurality of gaming machines to generate information identifying a position in the gaming establishment for each of the plurality of gaming machines;
a transceiver to receive electromagnetic signals from each location transmitter, the electromagnetic signals including performance data information about each of the plurality of gaming machines and the position information for each of the plurality of gaming machines in the gaming establishment;
a database for storing and correlating the position information with the performance data information for each gaming machine; and
a visual representation illustrating the position of each of the plurality of gaming machines in the gaming establishment and the correlated performance data information for each of the plurality of gaming machines.

2. The system of claim 1 wherein each location transmitter is an RFID transponder.

3. The system of claim 1 wherein each location transmitter is a GPS transponder.

4. The system of claim 1 wherein each location transmitter is located on an outside of a corresponding gaming machine.

5. The system of claim 1 wherein each location transmitter is located on an inside of a corresponding gaming machine.

6. The system of claim 2 wherein each RFID transponder includes a label optically readable by a human or an optical device.

7. The system of claim 1 wherein information about each of the gaming machines includes machine performance data.

8. The system of claim 7 wherein the gaming machines each further include a device for receiving player data.

9. The system of claim 8 wherein the player data, performance data, and position information are correlated and presented on a map.

10. The system of claim 1 wherein the transceiver is electromagnetically connected to a computer storing the database.

11. The system of claim 10 wherein the visual representation is displayed on a screen associated with the computer.

12. The system of claim 1 wherein the transceiver is mobile within the gaming establishment.

13. The system of claim 1 wherein the transceiver is at a fixed reference location remote from the gaming machines.

14. A gaming machine comprising:
a housing;
a display screen associated with the housing;
a device configured to facilitate a player initiating a game;
an indicator configured to advise the player whether he or she has won or lost the game; and
a position transmitter associated with the housing, wherein the position transmitter generates and transmits casino floor coordinate location information of the gaming machine and performance data associated with the gaming machine; and
wherein all gaming machines in a gaming establishment may be illustrated on a visual representation of the gaming establishment according to the casino floor coordinate location information of each gaming machine and including the performance data for each gaming machine.

15. The gaming machine of claim 14 wherein the position transmitter includes an RFID tag.

16. The gaming machine of claim 14 wherein the position transmitter is a GPS system.

17. A method for generating a visual representation of gaming machine location and performance data comprising:
attaching a position transmitter to a gaming machine;
providing data identifying the gaming machine to the position transmitter;
determining the casino floor coordinate location of the gaming machine;
transmitting the identifying data and data indicating a casino floor coordinate location of the gaming machine to a transceiver;
correlating the identifying data and the gaming machine casino floor coordinate location with machine performance data; and
generating the visual representation of a casino floor including the casino floor coordinate location for all gaming machines on the casino floor and the correlated machine performance data associated with each such gaming machine.

18. The method of claim 17 wherein the operation of generating includes presenting a table listing each machine serial number, position location, amount wagered and number of wagers made.

19. The method of claim 17 wherein the operation of attaching a position transmitter includes associating an RFID tag or a GPS system with the gaming machine.

20. The method of claim 17 wherein the operation of generating the visual representation includes presenting a map correlating player data, gaming machine performance data, and gaming machine location data.
